(19) United States
(12) Patent Application Publication
(10) Pub. No.: US 2026/0269655 A1
(43) Pub. Date: Sep. 10, 2026

(54) METHOD AND APPARATUS FOR WIRELESS CHARGING

(71) Applicant: ELECTRONICS AND TELECOMMUNICATIONS RESEARCH INSTITUTE, Daejeon (KR)

(72) Inventors: Sunghyun HWANG, Daejeon (KR); Jung Ick MOON, Daejeon (KR); Jae Cheol PARK, Daejeon (KR); Kyu-Min KANG, Daejeon (KR)

(73) Assignee: ELECTRONICS AND TELECOMMUNICATIONS RESEARCH INSTITUTE, Daejeon (KR)

(21) Appl. No.: 19/389,536

(22) Filed: Nov. 14, 2025

(30) Foreign Application Priority Data
Mar. 6, 2025 (KR) 10-2025-0029051

(51) Int. Cl. H02J 50/40; H02J 7/00; H02J 50/80

(52) U.S. Cl. CPC H02J 50/40; H02J 7/42; H02J 7/50; H02J 7/82; H02J 7/933; H02J 50/80

(57) ABSTRACT

A method and apparatus for wireless charging are provided. According to an embodiment, an operating method of a transmitter device for wirelessly transmitting power includes receiving respective characteristic information of a plurality of receiver devices required to cluster the plurality of receiver devices, from each of the plurality of receiver devices. The operating method includes clustering the plurality of receiver devices into at least one receiver device group, based on the characteristic information. The operating method includes, based on beam scheduling between each of receiver devices in a same receiver device group and the transmitter device, wirelessly charging each of the receiver devices in the same receiver device group.

### CROSS-REFERENCE TO RELATED APPLICATIONS

This application claims the benefit of Korean Patent Application No. 10-2025-0029051, filed on Mar. 6, 2025, in the Korean Intellectual Property Office, the entire disclosure of which is incorporated herein by reference for all purposes.

### BACKGROUND

### 1. Field of the Invention

The disclosure relates to a method and an apparatus for wireless charging.

### 2. Description of the Related Art

Wireless charging technology may be used in various application fields. For example, in Internet of Things (IoT) applications, technology for wirelessly charging multiple IoT devices may be used.

The above information is presented as related art only to assist with an understanding of the disclosure. None of the above may be applicable as prior art with regard to the disclosure.

### SUMMARY

An embodiment provides a method of simultaneously charging a plurality of electronic devices using a wireless charging device.

An embodiment reduces a time required to charge a plurality of electronic devices.

The technical aspects are not limited to the aforementioned aspects, and additional aspects of embodiments will be set forth in part in the description which follows and, in part, will be apparent from the description, or may be learned by practice of the disclosure.

According to an aspect, there is provided a transmitter device for wirelessly transmitting power including at least one processor including processing circuitry and at least one memory storing instructions. The instructions, when executed individually or collectively by the at least one processor, cause the transmitter device to perform a plurality of operations. The plurality of operations include receiving from each of a plurality of receiver devices respective characteristic information of the plurality of receiver devices required to cluster the plurality of receiver devices, clustering the plurality of receiver devices into at least one receiver device group, based on the characteristic information, and based on beam scheduling between each of receiver devices in a same receiver device group and the transmitter device, wirelessly charging each of the receiver devices in the same receiver device group.

The receiving may include lastly receiving the characteristic information of a second receiver device from the second receiver device among the plurality of receiver devices within a set time period from a time point when the characteristic information of a first receiver device is first received from the first receiver device among the plurality of receiver devices.

The characteristic information may include at least one of a mobility type, a duty cycle, a current charge level, a period of time elapsed from a previous charging end time to a current time, and a period of time taken to fully charge in a previous charging cycle of each of the plurality of receiver devices.

The plurality of operations may further include broadcasting a message including an identifier (ID) for identifying the same receiver device group and an ID of the receiver devices in the same receiver device group to the receiver devices in the same receiver device group, between a first time point at which the plurality of receiver devices is clustered into the at least one receiver device group and a second time point at which the beam scheduling is initiated.

The plurality of operations may further include receiving charging status information from each of the receiver devices in the same receiver device group while wirelessly charging each of the receiver devices in the same receiver device group in parallel.

The plurality of operations may further include terminating wireless charging of each of the receiver devices in the same receiver device group, based on a determination that a current charge level of each of the receiver devices in the same receiver device group identified from the charging status information satisfies a threshold value.

The wirelessly charging may include wirelessly charging each of the receiver devices in the same receiver device group in parallel, using an optimal beam between each of the receiver devices in the same receiver device group and the transmitter device determined via the beam scheduling.

According to an aspect, there is provided an operating method of a transmitter device for wirelessly transmitting power including receiving from each of a plurality of receiver devices respective characteristic information of the plurality of receiver devices required to cluster the plurality of receiver devices, clustering the plurality of receiver devices into at least one receiver device group, based on the characteristic information, and based on beam scheduling between each of receiver devices in a same receiver device group and the transmitter device, wirelessly charging each of the receiver devices in the same receiver device group.

The receiving may include lastly receiving the characteristic information of a second receiver device from the second receiver device among the plurality of receiver devices within a set time period from a time point when the characteristic information of a first receiver device is first received from the first receiver device among the plurality of receiver devices.

The characteristic information may include at least one of a mobility type, a duty cycle, a current charge level, a period of time elapsed from a previous charging end time to a current time, and a period of time taken to fully charge in a previous charging cycle of each of the plurality of receiver devices.

The operating method may further include broadcasting a message including an ID for identifying the same receiver device group and an ID of the receiver devices in the same receiver device group to the receiver devices in the same receiver device group, between a first time point at which the plurality of receiver devices is clustered into the at least one receiver device group and a second time point at which the beam scheduling is initiated.

The operating method may further include receiving charging status information from each of the receiver devices in the same receiver device group while wirelessly charging each of the receiver devices in the same receiver device group in parallel.

The operating method may further include terminating wireless charging of each of the receiver devices in the same receiver device group, based on a determination that a current charge level of each of the receiver devices in the same receiver device group identified from the charging status information satisfies a threshold value.

The wirelessly charging may include wirelessly charging each of the receiver devices in the same receiver device group in parallel, using an optimal beam between each of the receiver devices in the same receiver device group and the transmitter device determined via the beam scheduling.

According to an aspect, there is provided a non-transitory computer-readable storage medium storing instructions that, when executed by a processor, cause the processor to perform the operating method.

### BRIEF DESCRIPTION OF THE DRAWINGS

With regard to the description of the drawings, the same or similar reference numerals may be used for the same or similar components.

FIG. 1 is a diagram illustrating a wireless charging system according to an embodiment.

FIG. 2 is a diagram illustrating a transmitter device and a receiver device according to an embodiment.

FIG. 3 is a flowchart illustrating a wireless charging process according to an embodiment.

FIG. 4 is a diagram illustrating a wireless charging setup request message according to an embodiment.

FIG. 5 is a diagram illustrating a wireless charging setup response message according to an embodiment.

FIG. 6 is a schematic block diagram illustrating a transmitter device according to an embodiment.

FIG. 7 is a schematic block diagram illustrating a receiver device according to an embodiment.

### DETAILED DESCRIPTION

The following structural or functional descriptions of embodiments described herein are merely intended for the purpose of describing the embodiments described herein and may be implemented in various forms. However, it should be understood that these embodiments are not construed as limited to the illustrated forms.

Various modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to in another component or that still other component is interposed between the two components.

As used herein, the singular forms are intended to include the plural forms as well, unless the context clearly indicates otherwise. As used herein, each of such phrases as “A or B”, “at least one of A and B”, “at least one of A or B”, “A, B or C”, “at least one of A, B and C”, and “at least one of A, B, or C”, may include any one of, or all possible combinations of the items enumerated together in a corresponding one of the phrases. It should be further understood that the terms “comprises/comprising” and/or “includes/including” when used in this specification specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

As used in connection with embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. It should be understood that the following embodiments may be referenced, borrowed, or combined with each other. When describing the embodiments with reference to the accompanying drawings, like reference numerals refer to like components, and any repeated description related thereto will be omitted.

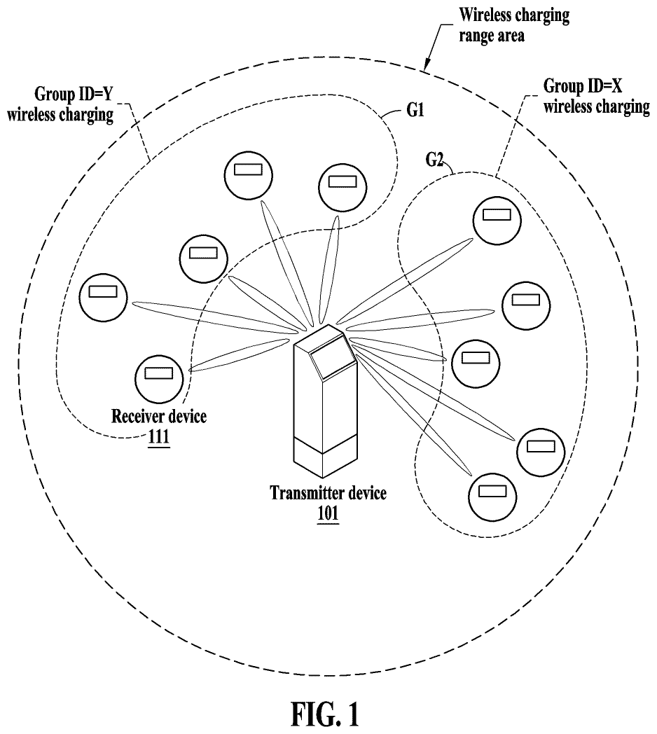

FIG. 1 is a diagram illustrating a wireless charging system according to an embodiment.

Referring to FIG. 1, according to an embodiment, a wireless charging system may include a transmitter device 101 and a plurality of receiver devices (e.g., a receiver device 111). In the disclosure, the transmitter device may be a device for wirelessly transmitting power to a receiver device, and the receiver device may be a device for wirelessly receiving power from the transmitter device.

The plurality of receiver devices may be clustered into at least one receiver device group. To cluster the plurality of receiver devices, characteristic information of the receiver devices may be used. The following Table 1 may be an example of the characteristic information used to cluster the plurality of receiver devices.

TABLE 1

| Category | Type |
|---|---|
| Mobility of receiver device | Fixed, mobile |
| Operation period | Long period, short period |
| Duty cycle | Long on time, short on time |
| Charging elapsed time | Long time, short time |
| Charging required time | Long time, short time |

In Table 1, mobility (or device type) may be characteristic information indicating whether a receiver device is a fixed device (e.g., a sensor) fixedly installed in a particular location or a mobile device (e.g., a wearable device) with no fixed installation location. An operation period may indicate a period during which a receiver device performs a particular task (e.g., sensor data collection, data processing, or data transmission). A duty cycle may indicate the amount of time a receiver device remains in an active state. A charging elapsed time may indicate a period of time from a past time point when a receiver device completed charging to a current time point. A charging required time may indicate a time taken for a receiver device to complete charging in a previous charging cycle.

Receiver devices having one or more identical characteristics may be clustered into a receiver device group. For example, the transmitter device 101 may cluster fixed devices into a first receiver device group G1 and cluster mobile devices into a second receiver device group G2. For example, the transmitter device 101 may cluster receiver devices that are fixed devices with long duty cycles into the first receiver device group G1 and cluster receiver devices that are mobile devices with short duty cycles into the second receiver device group G2.

The transmitter device 101 may assign an identifier (ID) to each receiver device group.

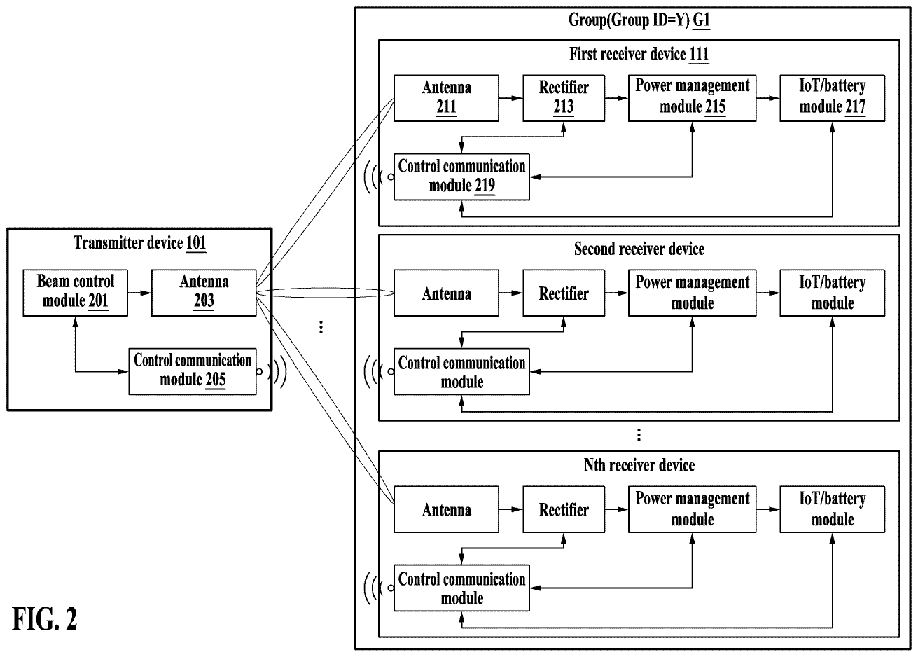

FIG. 2 is a diagram illustrating a transmitter device and a receiver device according to an embodiment.

Referring to FIG. 2, according to an embodiment, the transmitter device 101 may include a beam control module 201, an antenna 203 and a control communication module 205.

The transmitter device 101 may wirelessly transmit power and/or a signal (e.g., a control signal for wireless charging) in parallel (or simultaneously) to a plurality of receiver devices in the same receiver device group (e.g., the first receiver device group G1).

The transmitter device 101 may exchange control information for wireless charging with each receiver device via the control communication module 205. The transmitter device 101 may broadcast a control information message to a plurality of receiver devices in a group (e.g., the first receiver device group G1) of receiver devices having the same group ID (e.g., Y), via the control communication module 205. The transmitter device 101 may simultaneously control, and charge the plurality of receiver devices within the group of receiver devices having the same group ID via the control information message. The transmitter device 101 may also charge each of the plurality of receiver devices in the group of receiver devices having the same group ID in parallel, or charge sequentially at preset time intervals, via the control information message. According to an embodiment, as the transmitter device 101 simultaneously controls, and charges the plurality of receiver devices in the same receiver device group based on the group ID, the time required for charging may be reduced.

A receiver device (e.g., the receiver device 111) may include an antenna 211, a rectifier 213, a power management module 215, an Internet of Things (IoT)/battery module 217 and a control communication module 219.

The receiver device may exchange control information for wireless charging with the transmitter device 101 via the control communication module 219.

The receiver device may drive an IoT module using power provided from the transmitter device 101, or store power provided from the transmitter device 101 in a battery module, via the IoT/battery module 217.

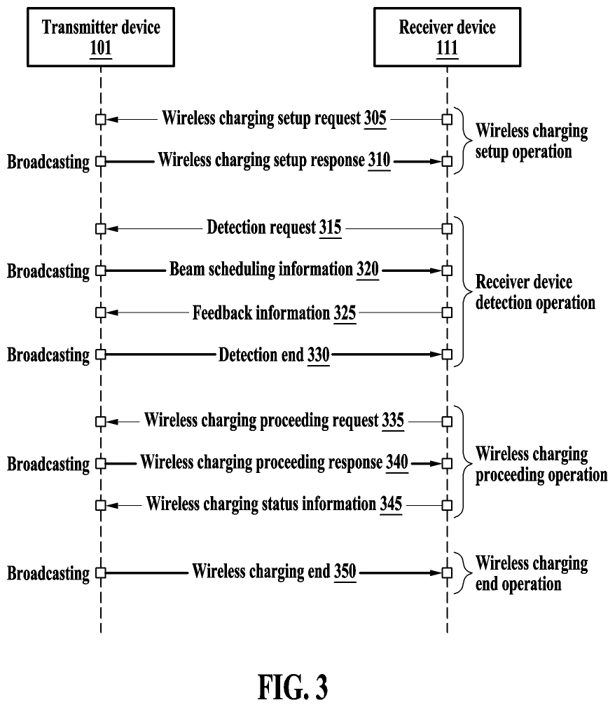

FIG. 3 is a flowchart illustrating a wireless charging process according to an embodiment.

Referring to FIG. 3, according to an embodiment, a wireless charging process between the transmitter device 101 and the receiver device 111 may include a wireless charging setup operation, a receiver device detection operation, a wireless charging proceeding operation, and a wireless charging end operation. In FIG. 3, for ease of description, a single receiver device 111 is shown, but it will be apparent to one of ordinary skill in the art that operations 305 to 350 may be performed between at least one receiver device other than the receiver device 111 and the transmitter device 101.

In operation 305, the receiver device 111 may transmit a wireless charging setup request message to the transmitter device 101. The receiver device 111 (e.g., an IoT device such as a sensor) may transmit the wireless charging setup request message to the transmitter device 101, based on a determination that battery charging of the receiver device 111 is required. The receiver device 111 may determine whether wireless charging is required for the receiver device 111 based on at least one of battery capacity and power consumption of the receiver device 111. The wireless charging setup request message may include control information for wireless charging. For example, the wireless charging setup request message may include the control information shown in Table 2 below.

TABLE 2

| Parameters | Description |
|---|---|
| Receiver ID | ID of receiver device |
| Device Type | Device type, mobility (fixed, mobile) |
| Operation Period | Operation period |
| Duty Cycle | Duty cycle |
| Current Battery Capacity | Current battery capacity |
| Charging Elapsed Time | Time elapsed since previous wireless charging |
| | ended |
| Charging Required Time | Time taken to fully charge battery in previous |
| | charging cycle |

In Table 2, “Receiver ID” may indicate an ID of a receiver device for identifying the receiver device. “Device Type” may indicate a type and/or mobility (e.g., a fixed device or mobile device) of a receiver device. “Operation Period” may indicate an operation period of a receiver device. “Duty Cycle” may indicate a duty cycle of a receiver device. “Current Battery Capacity” may indicate a current battery capacity of a receiver device. “Charging Elapsed Time” may indicate a period of time elapsed from a time when a previous wireless charging of a receiver device ended to a current time point. For example, when a last wireless charging end time of the receiver device is 12 hours and 32 minutes from the current time point, the “Charging Elapsed Time” may be 12 hours and 32 minutes. “Charging Required Time” may indicate a time taken to fully charge the battery in a previous charging cycle of a receiver device. For example, when it takes 3 hours to fully charge the battery in a previous charging cycle of the receiver device, the “Charging Required Time” may be 3 hours.

In operation 310, the transmitter device 101 may cluster the receiver device 111 into a receiver device group (e.g., the first receiver device group G1 of FIG. 2) based on the control information included in the wireless charging setup request message. As described above, at least one receiver device other than the receiver device 111 may transmit a wireless charging setup request message to the transmitter device 101, and the transmitter device 101 may cluster receiver devices based on control information included in the wireless charging setup request message received from the receiver devices within a reception time. The reception time may be a time period from when the wireless charging setup request message is first received from a particular receiver device until a predetermined amount of time has elapsed since the first reception. For example, when the transmitter device 101 receives a wireless charging setup request message from M (M being a natural number) receiver devices during the reception time, the transmitter device 101 may cluster M receiver devices.

The transmitter device 101 may broadcast a wireless charging setup response message to the receiver device 111 and other receiver devices within the receiver device group (e.g., the first receiver device group G1 of FIG. 2) including the receiver device 111 between a time when the receiver devices are clustered into the receiver device group and a time when beam scheduling for the receiver device 111 is initiated.

The transmitter device 101 may transmit the wireless charging setup response message to receiver devices within the same receiver device group. For example, the transmitter device 101 may transmit the wireless charging setup response message to the receiver device 111 and other receiver devices within the first receiver device group G1 including the receiver device 111.

The wireless charging setup response message may include control information on whether to proceed with wireless charging for the receiver device 111. For example, the wireless charging setup response message may include the control information shown in Table 3 below.

TABLE 3

| Parameters | Description |
|---|---|
| Transmitter ID | ID of transmitter device |
| Group ID | ID of receiver device group |
| For(i = 0; i < N; i++){ | |
| Receiver ID[i] | ID of receiver device |
| } | |
| Wireless Charging Flag | Indication of whether wireless charging is to be |
| | proceeded for receiver device |

In Table 3, “Transmitter ID” may indicate an ID of a transmitter device for identifying the transmitter device. “Group ID” may indicate an ID of a receiver device group including a receiver device. For example, when a transmitter device clusters N (N being a natural number less than M) receiver devices (e.g., the receiver device 111) among M receiver devices into a first receiver device group (e.g., the first receiver device group G1 of FIG. 2), the “Group ID” may be the ID (e.g., Y) of the first receiver device group. “Receiver ID” may indicate an ID of a receiver device for identifying the receiver device. When N receiver devices are included in the same receiver device group, an ID of each of the N receiver devices may be provided via the wireless charging setup response message. The receiver devices may identify whether their ID is included in a list of N Receiver IDs belonging to the group ID. “Wireless Charging Flag” may indicate whether wireless charging is to be proceeded for receiver devices included in a group.

In operation 315, the receiver device 111 may transmit a detection request message. The detection request message may include previous wireless charging history of the receiver device 111 and/or a type of the receiver device 111. Under certain conditions, a receiver device detection operation for the receiver device 111 may be omitted. For example, when the receiver device 111 has a history of being wirelessly charged by the transmitter device 101 and the receiver device 111 is a fixed device, the receiver device 111 may reuse a beam used in a previous wireless charging cycle for a current wireless charging without transmitting a detection request message to the transmitter device 101.

In operation 320, the transmitter device 101 may transmit a beam scheduling information message to the receiver device 111, and in operation 325, the receiver device 111 may transmit a feedback information message to the transmitter device 101.

The beam scheduling information message may include information (e.g., beam scheduling information) on a beam set by the transmitter device 101. For example, the beam scheduling information message may include the control information shown in Table 4 below.

TABLE 4

| Parameters | Description |
|---|---|
| Transmitter ID | ID of transmitter device |
| Group ID | ID of receiver device group |
| For(i = 0; i < N; i++){ | |
| Receiver ID[i] | ID of receiver device |
| Current Beam Index[i] | Index of beam currently in use for receiver device |
| } | |

In Table 4, “Transmitter ID” may indicate an ID of a transmitter device for identifying the transmitter device. “Group ID” may indicate an ID of a receiver device group including a receiver device. “Receiver ID” may indicate an ID of a receiver device for identifying the receiver device. “Current Beam Index” may indicate an index of a beam currently in use for a receiver device. When N receiver devices are included in the same receiver device group, an ID and beam index of each of the N receiver devices may be provided via the beam scheduling information message.

The feedback information message may include feedback information (e.g., a received signal strength indicator (RSSI), rectified voltage and/or rectified current) on a beam (e.g., a signal received through the beam) set by beam scheduling of the transmitter device 101. The transmitter device 101 may initiate beam scheduling for the receiver device 111 after a detection request message is received from the receiver device 111. The transmitter device 101 and the receiver device 111 may repeatedly exchange a beam scheduling information message and a feedback information message to select an optimal beam for wirelessly charging the receiver device 111 among a plurality of beams.

In operation 330, the transmitter device 101 may transmit a detection end message to the receiver device 111 after beam scheduling for wireless charging of the receiver device 111 has ended.

In operation 335, the receiver device 111 may transmit a wireless charging proceeding request message to the transmitter device 101.

In operation 340, the transmitter device 101 may transmit a wireless charging proceeding response message to the receiver device 111. The wireless charging proceeding response message may include control information required to wirelessly charge the receiver device 111. For example, the wireless charging proceeding response message may include the control information shown in Table 5 below.

TABLE 5

| Parameters | Description |
|---|---|
| Transmitter ID | ID of transmitter device |
| Group ID | ID of receiver device group |
| For(i = 0; i < N; i++){ | |
| Receiver ID[i] | ID of receiver device |
| Optimum Beam Index[i] | Index of optimal beam for wirelessly charging |
| | receiver device |
| } | |

In Table 5, “Transmitter ID” may indicate an ID of a transmitter device for identifying the transmitter device. “Group ID” may indicate an ID of a receiver device group including a receiver device. “Receiver ID” may indicate an ID of a receiver device for identifying the receiver device. “Optimum Beam Index” may indicate an index of an optimal beam for wirelessly charging a receiver device. When N receiver devices are included in the same receiver device group, an ID and optimal beam index of each of the N receiver devices may be provided through the wireless charging proceeding response message.

In operation 345, the receiver device 111 may transmit a wireless charging status information message to the transmitter device 101. The wireless charging status information message may include battery status information such as a current charge level and battery temperature of the receiver device 111. The receiver device 111 may repeatedly transmit a wireless charging status information message to the transmitter device 101 while wireless charging is being performed. For example, the receiver device 111 may periodically transmit the wireless charging status information message.

In operation 350, the transmitter device 101 may transmit a wireless charging end message to the receiver device 111. The transmitter device 101 may transmit the wireless charging end message based on a determination that the battery of the receiver device 111 is charged to a predetermined level (e.g., 95%) or more. The transmitter device 101 may identify a battery charge status of the receiver device 111, based on the wireless charging status information message received from the receiver device 111.

The transmitter device 101 may enter a standby state from a time when the wireless charging end message is transmitted until a wireless charging setup request message is received from a predetermined receiver device.

According to an embodiment, as a transmitter device clusters a plurality of receiver devices into at least one receiver device group, and broadcasts a message including control information to receiver devices included in the receiver device group using a receiver device group ID, it may be possible to transmit control information in a short time while efficiently using frequency resources.

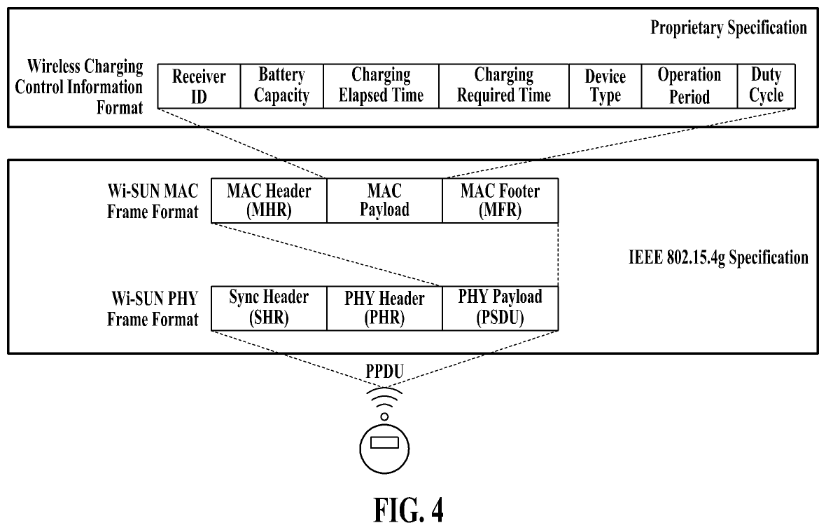

FIG. 4 is a diagram illustrating a wireless charging setup request message according to an embodiment.

Referring to FIG. 4, according to an embodiment, a wireless charging setup request message transmitted from a receiver device (e.g., the receiver device 111 of FIG. 3) to a transmitter device (e.g., the transmitter device 101 of FIG. 3) may be transmitted via a frame of an IEEE 802.15.4g standard.

Control information in a wireless charging setup request message may be carried in a medium access control (MAC) payload. A MAC header and a MAC footer may be added to the MAC payload, and the MAC header, MAC payload, and MAC footer may be carried in a physical layer (PHY) payload. To form a physical protocol data unit (PPDU), a sync header and a PHY header may be added to the PHY payload.

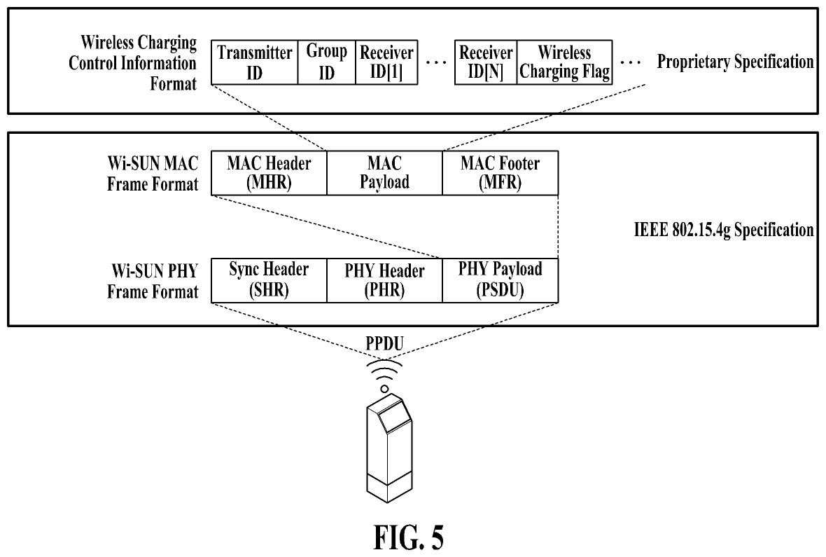

FIG. 5 is a diagram illustrating a wireless charging setup response message according to an embodiment.

Referring to FIG. 5, according to an embodiment, a wireless charging setup response message transmitted from a transmitter device (e.g., the transmitter device 101 of FIG. 3) to a receiver device (e.g., the receiver device 111 of FIG. 3) may be transmitted via a frame of an IEEE 802.15.4g standard.

Control information in a wireless charging setup response message may be carried in a MAC payload. A MAC header and a MAC footer may be added to the MAC payload, and the MAC header, MAC payload, and MAC footer may be carried in a PHY payload. To form a PPDU, a sync header and a PHY header may be added to the PHY payload.

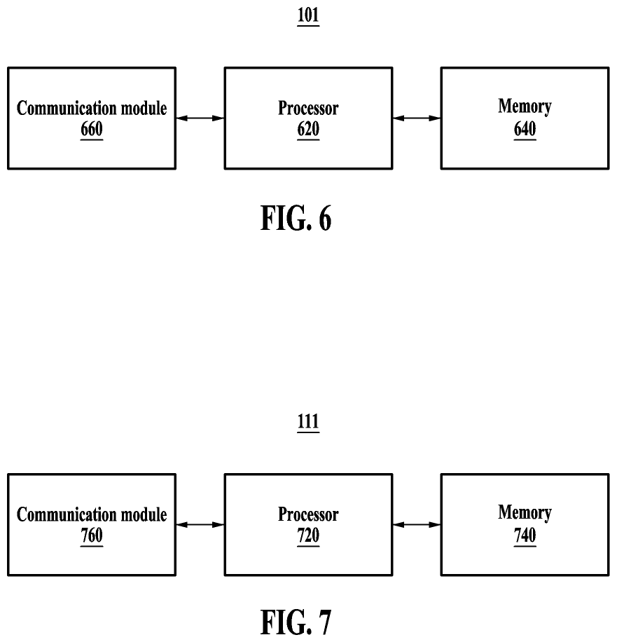

FIG. 6 is a schematic block diagram illustrating a transmitter device according to an embodiment.

Referring to FIG. 6, according to an embodiment, the transmitter device 101 may include at least one processor 620, memory 640 and a communication module 660.

The memory 640 may store instructions (or a program) executable by the at least one processor 620. For example, the instructions may include instructions for executing an operation of the at least one processor 620 and/or an operation of each component of the at least one processor 620.

The memory 640 may include one or more computer-readable storage media. The memory 640 may include non-volatile storage elements (e.g., magnetic hard disc, optical disc, floppy disc, flash memory, erasable programmable read-only memory (EPROM), and electrically erasable programmable read-only memory) (EEPROM)).

The memory 640 may be non-transitory media. The term “non-transitory” may indicate that a storage medium is not implemented as a carrier wave or a propagated signal. However, the term “non-transitory” should not be construed as the memory 640 not being able to be moved.

The at least one processor 620 may process data stored in the memory 640. The at least one processor 620 may execute computer-readable code (e.g., software) stored in the memory 640 and instructions triggered by the at least one processor 620.

The at least one processor 620 may be a hardware-implemented data processing device including circuitry having a physical structure for executing desired operations. For example, the desired operations may include code or instructions included in a program.

For example, the hardware-implemented data processing device may include a microprocessor, a CPU, a processor core, a multi-core processor, a multiprocessor, an ASIC, and an FPGA.

The at least one processor 620 may include a main processor (e.g., a CPU or an application processor) and an auxiliary processor (e.g., a communication processor, a neural processing unit (NPU) and/or graphics processing unit (GPU)).

The at least one processor 620 may cause the transmitter device 101 to perform at least one operation by individually or collectively executing code, instructions and/or an application stored in the memory 640.

The communication module 660 may establish a direct communication channel (e.g., a wired communication channel) or a wireless communication channel between the transmitter device 101 and at least one external device (e.g., a receiver device), and support communication via the established communication channel.

FIG. 7 is a schematic block diagram illustrating a receiver device according to an embodiment.

Referring to FIG. 7, according to an embodiment, the receiver device 111 may include at least one processor 720, memory 740 and a communication module 760.

The memory 740 may store instructions (or a program) executable by the at least one processor 720. For example, the instructions may include instructions for executing an operation of the at least one processor 720 and/or an operation of each component of the at least one processor 720.

The memory 740 may include one or more computer-readable storage media. The memory 740 may include non-volatile storage elements (e.g., magnetic hard disc, optical disc, floppy disc, flash memory, EPROM, and EEPROM).

The memory 740 may be non-transitory media. The term “non-transitory” may indicate that a storage medium is not implemented as a carrier wave or a propagated signal. However, the term “non-transitory” should not be construed as the memory 740 not being able to be moved.

The at least one processor 720 may process data stored in the memory 740. The at least one processor 720 may execute computer-readable code (e.g., software) stored in the memory 740 and instructions triggered by the at least one processor 720.

The at least one processor 720 may be a hardware-implemented data processing device including circuitry having a physical structure for executing desired operations. For example, the desired operations may include code or instructions included in a program.

For example, the hardware-implemented data processing device may include a microprocessor, a CPU, a processor core, a multi-core processor, a multiprocessor, an ASIC, and an FPGA.

The at least one processor 720 may include a main processor (e.g., a CPU or an application processor) and an auxiliary processor (e.g., a communication processor, an NPU and/or GPU).

The at least one processor 720 may cause the receiver device 111 to perform at least one operation by individually or collectively executing code, instructions and/or an application stored in the memory 740.

The communication module 760 may establish a direct communication channel (e.g., a wired communication channel) or a wireless communication channel between the receiver device 111 and at least one external device (e.g., a transmitter device), and support communication via the established communication channel.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as ROM, random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

Although one or more embodiments have been described with reference to the accompanying drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

The embodiments described herein are to be considered in a descriptive sense only, and not for purposes of limitation. It will be apparent to one of ordinary skill in the art that various changes in form and details may be made in the embodiments without departing from the spirit and scope of the claims and their equivalents. Additionally, it will be appreciated by one of ordinary skill in the art that any of the embodiments described herein can be used in conjunction with other embodiments described herein. Therefore, other implementations, embodiments, and equivalents to the claims are also within the scope of the following claims.

The effects that may be obtained from the present disclosure are not limited to the effects mentioned above, and other effects that are not mentioned may be clearly understood by one of ordinary skill in the art from the present disclosure.

What is claimed is:

1. A transmitter device for wirelessly transmitting power, the transmitter device comprising:
at least one processor including processing circuitry; and
at least one memory storing instructions that, when executed individually or collectively by the at least one processor, cause the transmitter device to perform a plurality of operations comprising:
receiving from each of a plurality of receiver devices respective characteristic information of the plurality of receiver devices required to cluster the plurality of receiver devices;
clustering the plurality of receiver devices into at least one receiver device group, based on the characteristic information; and
based on beam scheduling between each of receiver devices in a same receiver device group and the transmitter device, wirelessly charging each of the receiver devices in the same receiver device group.

2. The transmitter device of claim 1, wherein the receiving comprises:
lastly receiving the characteristic information of a second receiver device from the second receiver device among the plurality of receiver devices within a set time period from a time point when the characteristic information of a first receiver device is first received from the first receiver device among the plurality of receiver devices.

3. The transmitter device of claim 1, wherein the characteristic information comprises:
at least one of a mobility type, a duty cycle, a current charge level, a period of time elapsed from a previous charging end time to a current time, and a period of time taken to fully charge in a previous charging cycle of each of the plurality of receiver devices.

4. The transmitter device of claim 1, wherein the plurality of operations further comprises:
broadcasting a message comprising an identifier (ID) for identifying the same receiver device group and an ID of the receiver devices in the same receiver device group to the receiver devices in the same receiver device group, between a first time point at which the plurality of receiver devices is clustered into the at least one receiver device group and a second time point at which the beam scheduling is initiated.

5. The transmitter device of claim 1, wherein the plurality of operations further comprises:
receiving charging status information from each of the receiver devices in the same receiver device group while wirelessly charging each of the receiver devices in the same receiver device group in parallel.

6. The transmitter device of claim 5, wherein the plurality of operations further comprises:
terminating wireless charging of each of the receiver devices in the same receiver device group, based on a determination that a current charge level of each of the receiver devices in the same receiver device group identified from the charging status information satisfies a threshold value.

7. The transmitter device of claim 1, wherein the wirelessly charging comprises:
wirelessly charging each of the receiver devices in the same receiver device group in parallel, using an optimal beam between each of the receiver devices in the same receiver device group and the transmitter device determined via the beam scheduling.

8. An operating method of a transmitter device for wirelessly transmitting power, the operating method comprising:
receiving from each of a plurality of receiver devices respective characteristic information of the plurality of receiver devices required to cluster the plurality of receiver devices;
clustering the plurality of receiver devices into at least one receiver device group, based on the characteristic information; and
based on beam scheduling between each of receiver devices in a same receiver device group and the transmitter device, wirelessly charging each of the receiver devices in the same receiver device group.

9. The operating method of claim 8, wherein the receiving comprises:
lastly receiving the characteristic information of a second receiver device from the second receiver device among the plurality of receiver devices within a set time period from a time point when the characteristic information of a first receiver device is first received from the first receiver device among the plurality of receiver devices.

10. The operating method of claim 8, wherein the characteristic information comprises:
at least one of a mobility type, a duty cycle, a current charge level, a period of time elapsed from a previous charging end time to a current time, and a period of time taken to fully charge in a previous charging cycle of each of the plurality of receiver devices.

11. The operating method of claim 8, further comprising:
broadcasting a message comprising an identifier (ID) for identifying the same receiver device group and an ID of the receiver devices in the same receiver device group to the receiver devices in the same receiver device group, between a first time point at which the plurality of receiver devices is clustered into the at least one receiver device group and a second time point at which the beam scheduling is initiated.

12. The operating method of claim 8, further comprising:
receiving charging status information from each of the receiver devices in the same receiver device group while wirelessly charging each of the receiver devices in the same receiver device group in parallel.

13. The operating method of claim 12, further comprising:
terminating wireless charging of each of the receiver devices in the same receiver device group, based on a determination that a current charge level of each of the receiver devices in the same receiver device group identified from the charging status information satisfies a threshold value.

14. The operating method of claim 8, wherein the wirelessly charging comprises:
wirelessly charging each of the receiver devices in the same receiver device group in parallel, using an optimal beam between each of the receiver devices in the same receiver device group and the transmitter device determined via the beam scheduling.

15. A non-transitory computer-readable storage medium storing instructions that, when executed by a processor, cause the processor to perform the method of claim 8.
